(19) United States
(12) Patent Application Publication
(10) Pub. No.: US 2013/0147770 A1
(43) Pub. Date: Jun. 13, 2013

(54) CONTROL OF ELECTRONIC DEVICES

(71) Applicant: Elliptic Laboratories AS, Olso (NO)

(72) Inventors: Tobias DAHL, Oslo (NO); Bjorn Cato SYVERSRUD, Oslo (NO)

(73) Assignee: Elliptic Laboratories AS, Olso (NO)

(21) Appl. No.: 13/758,880

(22) Filed: Feb. 4, 2013

Related U.S. Application Data
(63) Continuation of application No. PCT/GB2011/051468, filed on Aug. 3, 2011.

(30) Foreign Application Priority Data
Aug. 4, 2010 (GB) 1013117.5

(51) Int. Cl. G06F 3/043

(52) U.S. Cl. CPC G06F 3/043
USPC 345/177; 345/173

(57) ABSTRACT

An electronic device such as a smart-phone, has an active state in which it is able to receive inputs from an input object and a standby state in which at least one of said inputs is disabled. The device is configured to be switchable from the standby state to the active state upon the detection of the presence of the input object within a predetermined distance of the device and the subsequent detection of a predetermined user action.

This Application is a Continuation of International Application No. PCT/GB2011/051468 filed Aug. 3, 2011, which claims benefit of priority to GB 1013117.5 filed Aug. 4, 2010, both of which are hereby incorporated by reference.

This invention relates to inputs for electronic devices and in particular to retrieving such devices from a standby state.

In recent years there has been an explosion in the number and type of electronic devices on the consumer market, particularly mobile devices such as smart phones, laptops, PDAs, tablet computers etc. There is an ongoing requirement in such devices to minimise the use of power and thus extend battery life. This has commonly led to the provision of a “standby” state for the devices in which operation of the device is kept to a minimum. Related to this, particularly in the context of mobile devices, is the need to avoid false detection of user inputs when a device is not being used but is placed in a bag, pocket etc.

Proposals have been made for devices with new input types such as touchless interaction which, the applicant has appreciated, introduces additional configurations particularly in the area of avoiding spurious detection of inputs that were not intended by a user.

When viewed from a first aspect the present invention provides an electronic device with an active state in which it is able to receive inputs from an input object and a standby state in which at least one of said inputs is disabled, the device further being configured to be switchable from said standby state to said active state upon the detection of the presence of said input object within a predetermined distance of the device and the subsequent detection of a predetermined user action.

The invention extends to a method of operating an electronic device with an active state in which it is able to receive inputs from an input object and a standby state in which at least one of said inputs is disabled, comprising detecting the presence of said input object within a predetermined distance of the device, subsequently detecting a predetermined user action and then switching from said standby state to said active state.

The invention also extends to computer software or a computer program product either whether or not on a carrier, which is adapted when executed on suitable processing means to: detect the presence of an input object within a predetermined distance of an electronic device, subsequently detect a predetermined user action and then switch the device to an active state in which it is able to receive inputs from the input object from a standby state in which at least one of said inputs is disabled.

Thus it will be seen by those skilled in the art that in accordance with the invention there is provided a means of “waking up” an electronic device from a standby state by detecting that an input object which is used to control the device, e.g. a user's finger, is within a certain proximity of the device. Only then will the device be receptive to the predetermined user action being performed in order to bring the device out of the standby state. This gives an intuitive way of conveniently being able to retrieve the device from its standby state whilst avoiding the inadvertent interpretation of an unintended user input.

The invention can be applied to devices comprising a touch-pad or a touch-screen to receive inputs from the input object in the active state, in which case the input object will typically be a user's finger or a stylus. However, this is not essential and in another set of embodiments, the device is configured to receive inputs from the movement of an input object in front of an input surface—i.e. so-called touchless interaction.

The predetermined user action which initiates switching from the standby state to the active state after proximity of the input object has been detected may take a variety of different forms. For example, in one set of embodiments the predetermined user action comprises a touchless gesture—i.e. movement of an input object in front of the device or an input surface thereof. This is preferably, but not necessarily, the same as the input object whose proximity to the device is determined in accordance with the invention. Similarly the input object is preferably, but not necessarily, the same as the input object which is used to determine input to the device during the active state. An example of a possible touchless gesture which could constitute the predetermined user action would be a movement of the input object towards the device followed by a movement away. This could be used to mimic a virtual button press or screen tap without requiring actual contact with the device, although preferably in such embodiments the predetermined user action is defined so as to encompass movements in which the device is touched.

In another set of embodiments, the predetermined user action requires actually touching the device—e.g. by means of a touch-screen or touch-pad. In another set of embodiments, the predetermined user action comprises maintaining the input object within a predetermined area for a predetermined amount of time—i.e. executing a “hover” action.

The subsequent detection of the predetermined user action could take place at any time after detection of the input object. In particular it is not essential for there to be any minimum time so that the subsequent user action detection could be effectively simultaneous. Preferably a time window is defined—typically of fixed duration and/or typically commencing with detection of the proximity of the input object, during which the predetermined user action can be performed in order to switch the device from the standby state.

In general it is preferred that the predetermined user action is of the same type of input as the inputs which the device receives during the active state. For example, if the device is a touch-screen device, the predetermined action would comprise a user touching the screen. In another example, if the device has a touchless interaction mode, the predetermined user action could be a touchless gesture or other movement. However, this is not essential and the predetermined user action could, for example, be a touchless gesture even though no general touchless user interface were provided for use during the active state. This could be advantageous in some embodiments for practical reasons since, for example, it may allow a relatively crude predetermined user action in the form of a touchless gesture to be determined simply using, for example, ultrasound total reflected energy which involves using the loudspeaker and microphone already provided on a device—i.e. without the need to add additional hardware.

In a set of preferred embodiments the device is configured to give an indication when presence of the input object is detected within the predetermined distance. This can act as a prompt to the user to carry out the predetermined user action to complete the switch out of the standby state. The indication could take any convenient form—e.g. an audible or visual indication. In a preferred set of embodiments the indication comprises displaying a graphical element at a predetermined position on a display screen. Where the device comprises a touch-screen the graphical element may indicate a point on the screen which the user needs to touch to perform the predetermined user action. For example the graphical element might resemble a button, target, icon or the like. Where the predetermined user action is a touchless gesture, the graphical element may indicate that the gesture should be carried out above it. The graphical element could prompt the user as to what the necessary predetermined user action is. For example it could comprise text (“Press Here”) or a diagram indicating what the touchless gesture should be (e.g. a circular arrow).

The means for detecting presence of the input object within a predetermined distance of the device could be configured in a number of ways. It could be configured so that the distance is measured from a single point on the device—thereby giving a hemispherical proximity zone. Alternatively it could be defined as the aggregate distance to two separated points—thereby giving an ellipsoid proximity zone. The distance need not be the only criterion; the angle could be taken into consideration as well.

In one set of embodiments the device is configured to have a proximity zone—that is a zone within which the input object is detected as being within the predetermined distance—which is defined by one or more planes. One such plane could be a surface of the device. In a set of embodiments the proximity zone comprises a cuboid. An example of this would be that the input object is detected if it is above a defined surface or part of a surface on the device (e.g. a screen) and is within a predetermined distance from the surface. The predetermined distance thus defines the height of the cuboid proximity zone.

Detection of the input object within a predetermined distance of the device, and detection of the predetermined user action could each be carried out in a variety of different ways and, as discussed above, different techniques could be employed for each. For example capacitive, visual or infra-red detection could be used for either. In a set of preferred embodiments detection of the proximity of the input object is carried out by receipt of an acoustic signal reflected from the input object. Additionally or alternatively detection of the predetermined user action could be carried out using reflection of an acoustic signal, particularly where the predetermined user action comprises a movement of a or the input object.

In one set of embodiments the above-mentioned acoustic signal is ultrasonic, i.e. it has a frequency greater than 20 kHz e.g. between 30 and 50 kHz. In a convenient set of embodiments, the transmitter and/or receiver, preferably both of them, is also used by the device for transmission/reception of audible signals. This means that the standard microphone(s) and/or speaker(s) of the device, which might e.g. be a smart phone, can advantageously be employed since these will typically be operable at ultrasound frequencies even if not necessarily intended for this. It will be appreciated that this gives a particularly attractive arrangement since it opens up the possibility of providing the additional functionality described herein to an electronic device without having to add any additional hardware. In another set of embodiments lower frequency acoustic signals could be used, e.g. with a frequency of 17 kHz or greater which may not be audible to most people.

In the context of detecting the predetermined user action, use could even be made of signals which are clearly in the audible range, recognising that in accordance with preferred embodiments of the invention the signals need only be transmitted for a short period of time after the proximity of the input object is detected. In fact the sound could be used positively as an indication to encourage completion of the predetermined user action to ‘wake up’ the device.

In a set of embodiments in accordance with the invention, which may well include many examples of those mentioned above in which the existing microphone and speaker are employed, detection of the input object and/or the predetermined user action can be carried out using just a single channel i.e. one transmitter-receiver pair. Whilst this would not normally be considered sufficient for a touchless movement or gesture recognition system, the Applicant has recognised that this is sufficient for the detection of proximity or crude movements.

Acousitc, e.g. ultrasound, transmissions in accordance with some preferred embodiments, could take any convenient form. In a simple set of embodiments they take the form of a series of discrete transmissions. Each such transmission could comprise a single impulse or spike, i.e. approximating a Dirac delta function within the limitations of the available bandwidth. This has some advantages in terms of requiring little, if any, processing of the ‘raw signal’ to calculate impulse responses (in the theoretical case of a pure impulse, no calculation is required) but gives a poor signal-to-noise ratio because of the deliberately short transmission. In other embodiments the transmit signals could be composed of a series or train of pulses. This gives a better signal-to-noise ratio than a single pulse without greatly increasing the computation required. In other embodiments the transmit signals comprise one or more chirps—i.e. a signal with rising or falling frequency. These give a good signal-to-noise ratio and are reasonable for calculating the impulse responses using a corresponding de-chirp function applied to the ‘raw’ received signal. In other embodiments a pseudo-random codes—e.g. a Maximum Length Sequence pseudo-random binary code could be used. In a set of embodiments a continuous transmission can be employed.

In a set of possible embodiments a reflected ultrasonic signal is used to detect motion of input object corresponding to the predetermined user action. The motion could be detected using the frequency of the received signal—e.g. detecting a Doppler shift or more complex change in the frequency spectrum. Additionally or alternatively, the signal received from two or more consecutive transmissions or periods of transmission may be analysed for a particular trend. The “raw” received signal could be used or the impulse response could be calculated. A filter such as a line filter could then be applied on either the raw signal or the impulse responses in order to detect particular motions. A single line filter could be used or a plurality could be used e.g. looking for the best match. Further details of such arrangements are disclosed in WO 2009/115799.

The electronic device could be any of a wide variety of possible devices, for example a hand-held mobile device such as a smart phone or a stationary device. The device could be self-contained or merely an input or controller module for another device—thus it could be a remote control device for a piece of equipment to a games controller.

The invention is not limited to a single predetermined user action. Applications can be envisaged which require more than one such action—e.g. a screen lock, keyboard lock or the like to provide greater protection against accidental operation—or a requirement to enter a password.

The Applicant has further appreciated that the invention outlined above can also be applied to ‘waking up’ or activating a particular application of function on a device rather than bringing the whole device out of standby and thus when viewed from a further aspect the invention provides an electronic device comprising a function or application with an active state in which it is able to receive inputs from an input object and a standby state in which at least one of said inputs is disabled, the application further being configured to be switchable from said standby state to said active state when the device detects the presence of said input object within a predetermined distance of the device and subsequently detects a predetermined user action.

The invention extends to a method of operating an electronic device comprising a function or application with an active state in which it is able to receive inputs from an input object and a standby state in which at least one of said inputs is disabled, comprising detecting the presence of said input object within a predetermined distance of the device, subsequently detecting a predetermined user action and then switching said function or application from said standby state to said active state.

The invention also extends to computer software or a computer program product either whether or not on a carrier, which is adapted when executed on suitable processing means to: detect the presence of an input object within a predetermined distance of an electronic device, subsequently detect a predetermined user action and then switch an application or function of the device to an active state in which it is able to receive inputs from the input object from a standby state in which at least one of said inputs is disabled.

A particular embodiment of the invention will now be described, by way of example only, with reference to the accompanying drawings in which:

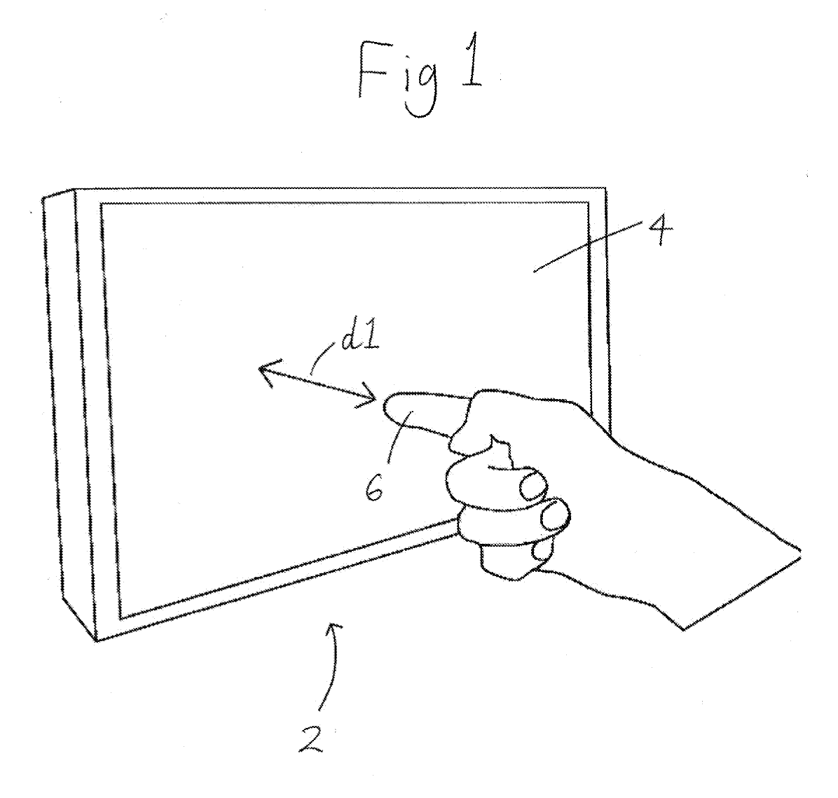

FIG. 1 is a schematic illustration of a user's finger approaching a touch-screen device;

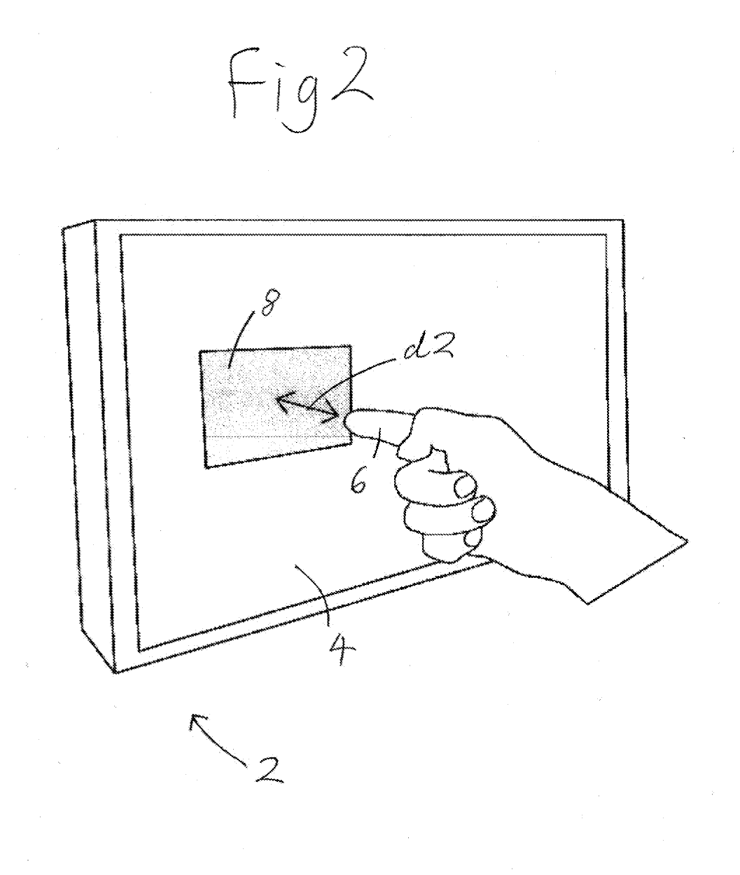

FIG. 2 is an illustration of the finger moving close enough for a button to be displayed; and

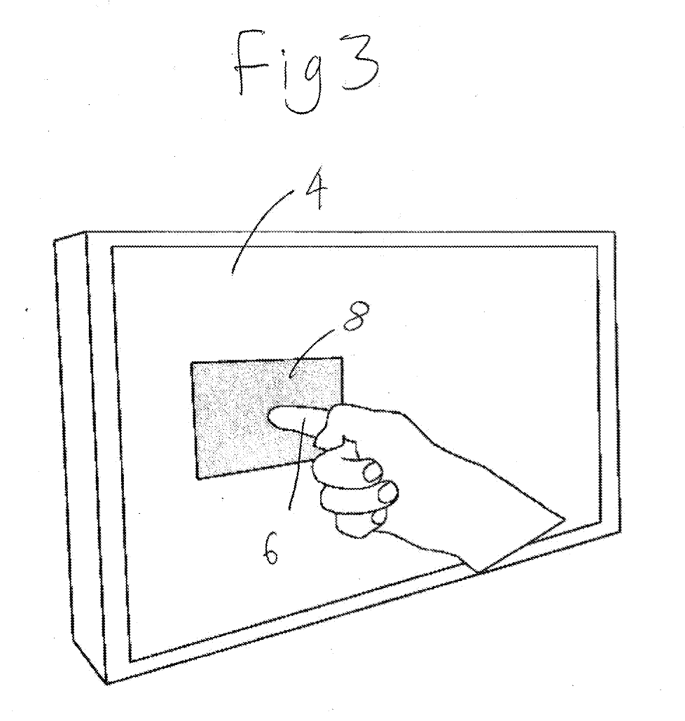

FIG. 3 is an illustration of the user pressing the button.

Turning first to FIG. 1, there may be seen an electronic device which could be any touch-screen operated device such as a tablet computer. The device comprises a touch-sensitive screen 4 covering most of its front face, the touch-screen 4 being able to detect the presence and location of a touch by a user's finger 6. In FIG. 1 the user's finger is a distance d1 away from the screen. This distance is greater than a predetermined threshold. At this stage the device may be in a standby state in which most of its operations are shut down, the display is turned off and the touch-screen 4 is not responsive to touches across most of its surface.

FIG. 2 shows the finger 6 now being closer to the screen, separated only by a distance d2 which is equal to the predetermined threshold. The finger is detected as being within the threshold distance d2 by the touch-screen 4 detecting a threshold change in capacitance in the region above the screen. The device 2 responds to detection of the finger 6 by displaying an indication in the form of a graphical element 8. This is only shown schematically and the particular appearance can be chosen as desired.

The graphical element 8 is displayed in a predetermined part of the screen 4. The device can be configured such that the graphical element 8 is displayed whenever a finger 6 is within the distance d2 of any part of the screen, or only when it is within the distance d2 of where the graphical element d2 is to be displayed.

Once the graphical element 8 has been displayed, the user can touch the screen 4 on any part of the graphical element it to re-activate the device as shown in FIG. 3. Thereafter the device 2 can be operated as normal until it is once again placed into a standby state—either positively by the user or after a period of inactivity. In alternative embodiments the actions above can activate one or more functions or applications of the device rather than waking up the whole device.

There are many alternatives to the use of a change in capacitance to detect proximity of the finger (or other input object) and to the use of a touch-screen to complete the wake-up process. For example, one or both of these may be replaced by analysing the reflections of an acoustic, e.g. ultrasonic signal, which could be transmitted and received through the ordinary loudspeaker and microphone of the device and/or through one or more dedicated transducers. Further details on how this can be achieved are given in WO 2009/147398.

1. An electronic device comprising a display screen, the electronic device having an active state in which it is configured to receive inputs from movements of an input object in front of said display screen and a standby state in which at least one of said inputs is disabled, the device further being configured to be switchable from said standby state to said active state upon the detection of the presence of said input object within a predetermined distance of the device and the subsequent detection of a predetermined user action, wherein said electronic device is arranged to display a graphical element at a predetermined position on said display screen when said presence of the input object is detected within the predetermined distance.

2. A device as claimed in claim 1, wherein the predetermined user action comprises movement of said input object in front of the display screen.

3. A device as claimed in claim 2 wherein said input object, movement of which comprises the predetermined user action, is the same as the input object whose proximity to the device is determined in accordance with claim 1.

4. A device as claimed in claim 2 wherein the predetermined user action comprises a movement of the input object towards the display screen followed by a movement away.

5. A device as claimed in claim 1 wherein the predetermined user action requires actually touching the device.

6. A device as claimed in claim 1 wherein the predetermined user action comprises maintaining the input object within a predetermined area for a predetermined amount of time.

7. A device as claimed in claim 1 arranged to define a time window during which the predetermined user action can be performed in order to switch the device from the standby state.

8. A device as claimed in claim 1 configured to have a proximity zone within which the input object is detected as being within the predetermined distance, which is defined by one or more planes.

9. A device as claimed in claim 8 wherein the proximity zone comprises a cuboid.

10. A device as claimed in claim 1 wherein detection of the proximity of the input object is carried out by receipt of an acoustic signal reflected from the input object.

11. A device as claimed in claim 1 wherein detection of the predetermined user action is carried out using reflection of an acoustic signal.

12. A device as claimed in claim 10 wherein the acoustic signal is ultrasonic.

13. A device as claimed in claim 10 comprising a transmitter and/or receiver which is/are also used by the device for transmission and/or reception of audible signals.

14. A device as claimed in claim 1 arranged to detect the input object and/or the predetermined user action using just a single channel comprising a transmitter-receiver pair.

15. An electronic device comprising a display screen and further comprising a function or application with an active state in which it is configured to receive inputs from movements of an input object in front of said display screen and a standby state in which at least one of said inputs is disabled, the application further being configured to be switchable from said standby state to said active state when the device detects the presence of said input object within a predetermined distance of the device and subsequently detects a predetermined user action wherein said electronic device is arranged to display a graphical element at a predetermined position on said display screen when said presence of the input object is detected within the predetermined distance

16. Computer software or a computer program product either on a carrier or not, which is adapted when executed on suitable processing means to: detect the presence of an input object within a predetermined distance of an electronic device having a display screen, subsequently detect a predetermined user action and then switch the device to an active state in which it is configured to receive inputs from movements of the input object in front of the display screen from a standby state in which at least one of said inputs is disabled.

17. Computer software or a computer program product either on a carrier or not, which is adapted when executed on suitable processing means to: detect the presence of an input object within a predetermined distance of an electronic device having a display screen, subsequently detect a predetermined user action and then switch an application or function of the device to an active state in which it is configured to receive inputs from movements of the input object in front of the display screen from a standby state in which at least one of said inputs is disabled.
